(19) United States
(12) Patent Application Publication
(10) Pub. No.: US 2023/0235623 A1
(43) Pub. Date: Jul. 27, 2023

(54) IMPACT RESISTANT OPERABLE BLIND

(71) Applicant: Privacy Glass Solutions, Coral Springs, FL (US)

(72) Inventor: Kevin ROTH, Parkland, FL (US)

(73) Assignee: Privacy Glass Solutions, Coral Springs, FL (US)

(21) Appl. No.: 17/584,754

(22) Filed: Jan. 26, 2022

(51) Int. Cl. E06B 9/264; E06B 3/677; E06B 9/28

(52) U.S. Cl. CPC E06B 9/264; E06B 3/677; E06B 9/28; E06B 2009/2646; E06B 2009/285

(57) ABSTRACT

An impact resistant operable blind includes a sealed impact resistant unit including a first glass layer and a second laminated glass layer spaced from the first glass layer and defining a sealed chamber therebetween. The second laminated glass layer includes a first heat strengthened glass layer laminated to a second heat strengthened glass layer by an interlayer. A blind unit is disposed within the sealed chamber and includes a tiltrod supported at a top of the sealed chamber and supporting a plurality of ladder strings that support a plurality of slats.

### FIELD

The present disclosure relates to an impact resistant operable blind.

### BACKGROUND

This section provides background information related to the present disclosure which is not necessarily prior art.

Between glass blinds are used in doors and walls in which it is designed to provide an open view and to provide the option of allowing privacy on demand to provide maintenance free and customizable privacy control windows. Between glass blinds panels are known for use in commercial and residential windows, medical facilities, business environments, educational facilities, and numerous other environments for providing privacy when desired or needed.

It is desirable to provide between glass blinds with impact resistance protection against hurricanes and other storms with high winds where debris become projectiles.

### SUMMARY

This section provides a general summary of the disclosure, and is not a comprehensive disclosure of its full scope or all of its features.

According to an aspect of the present disclosure, an impact resistant operable blind includes a sealed impact resistant unit including a first glass layer and a second laminated glass layer spaced from the first glass layer and defining a sealed chamber therebetween. The second laminated glass layer includes a first heat strengthened glass layer laminated to a second heat strengthened glass layer by an 090 interlayer. A blind unit is disposed within the sealed chamber and includes a tiltrod supported at a top of the sealed chamber and supporting a plurality of ladder strings that support a plurality of slats.

According to another aspect, the impact resistant operable blind includes the first heat strengthened glass layer and the second heat strengthened glass layer are at least ¼ inch thick that make up a laminated layer that is 9/16 inch thick with the 090 interlayer.

According to yet another aspect, the impact resistant operable blind includes a magnetic device and tilt actuator for rotating the tiltrod to adjust a tilt of the plurality of slats.

According to a further aspect, the sealed chamber is filled with Argon gas.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of an impact resistant operable blind according to the principles of the present disclosure;

FIG. 2 is a partial cross-sectional view of the impact resistant operable blind taken along line 2-2 of FIG. 1;

FIG. 3 is a partial plan view of the impact resistant operable blind with the blind shown in a closed position;

FIG. 4 is a partial plan view of the impact resistant operable blind with the blind shown in an open position; and

FIG. 5 is a plan view of an impact resistant operable blind with a second laminated glass layer removed to show the blind assembly.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

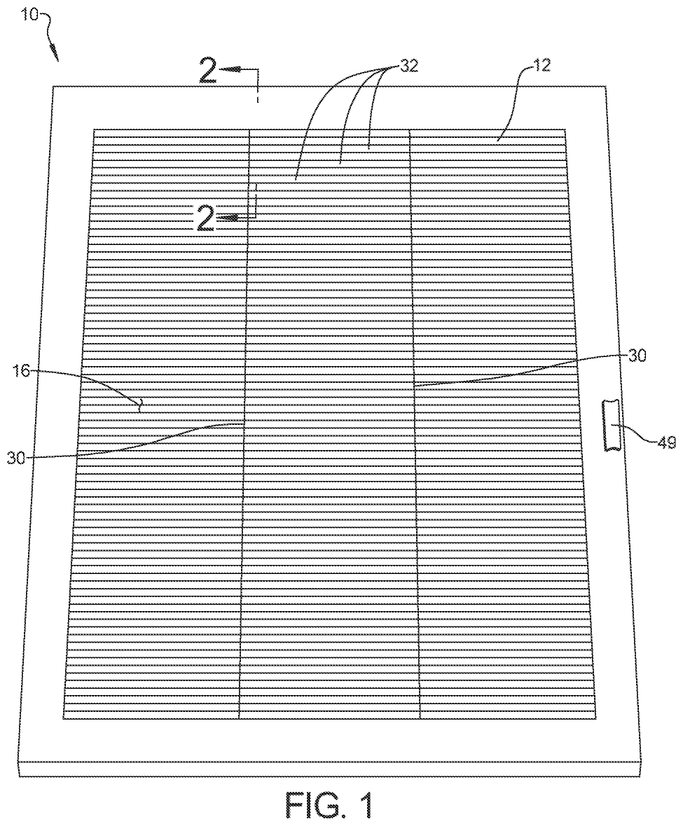

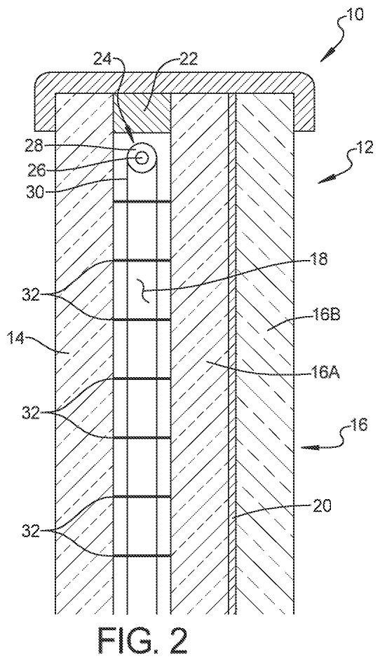

With reference to FIGS. 1 and 2, an impact resistant operable blind 10 is shown including a sealed impact resistant unit 12 including a first glass layer 14 and a second laminated glass layer 16 spaced from the first glass layer 14 and defining a sealed chamber 18 therebetween. The second laminated glass layer 16 includes a first heat strengthened glass layer 16A laminated to a second heat strengthened glass layer 16B by an interlayer 20. A spacer 22 is provided between the first glass layer 14 and the second laminated glass layer 16.

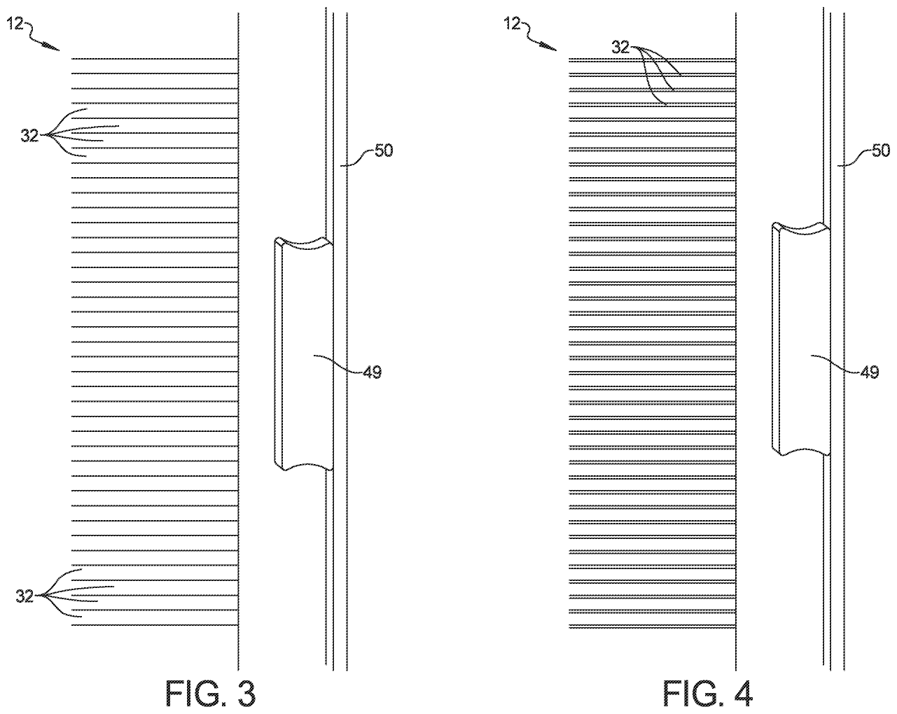

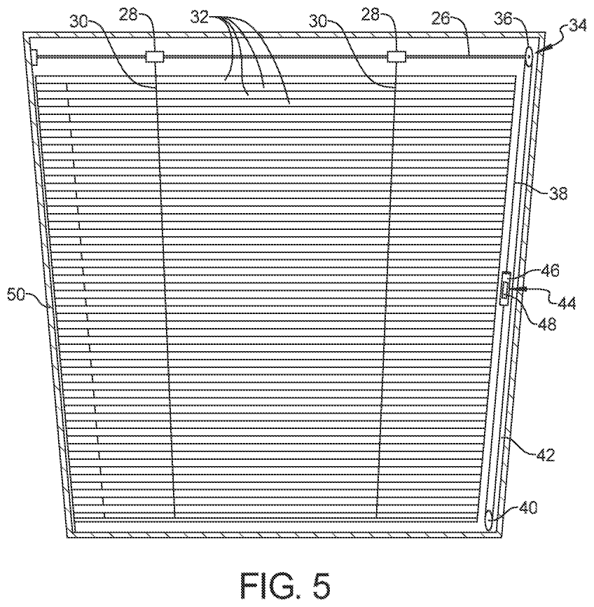

With reference to FIGS. 2 and 5, a blind assembly 24 is disposed in the sealed chamber 18 of the sealed impact resistant unit 12. The blind assembly 24 can include a tiltrod 26 supported at a top of the sealed chamber 18 and including a plurality of drums 28 each supporting a ladder string 30. The ladder strings 30 support a plurality of slats 32 in a horizontal position. As best shown in FIG. 5, a tilter mechanism 34 includes a tilt drum 36 connected to the tiltrod 26. A tilt cord 38 extends around the tilt drum 36 and a guide drum 40 mounted in a side channel 42 of the sealed chamber 18. The tilt cord 38 supports a magnetic response device 44 including a frame 46 and a ferromagnetic material 48 supported by the frame 46. A magnetic tilt actuator 49 (FIG. 3) is provided on an exterior of the sealed chamber 18 adjacent to the magnetic response device 44 and is vertically movable to cause the magnetic response device 44 to move therewith to cause the tilt cord to rotatably drive the tilt drum 36 and the tiltrod 26 to move the ladder strings 30 between horizontal and vertical support positions.

As the ladder strings 30 are manipulated between horizontal and vertical support positions, the slats 32 supported by the ladder strings 30 are pivoted between a horizontal position where a user can see through the blind assembly 24, as shown in FIGS. 2 and 4, and a vertical position where vision through the blind assembly 24 is obstructed, as shown in FIGS. 1, 3 and 5. A frame 50 is disposed around the sealed impact resistant unit.

The impact resistant operable blind 10 is designed to allow a between glass blind to be utilized in an environment where it is also desirable to provide the added security of an impact resistant window. The impact resistant operable blind 10 is magnetically operated so that the magnetic tilt actuator 49 can act through the glass on the magnetic response device 44 to operate the blind assembly 24 between open and closed positions.

Impact resistance is an important factor for protection against hurricanes and other storms with high winds where debris become projectiles. In order to obtain an impact resistant rating, testing is performed. Missile level D is the most common testing rating and represents “large missile impact” known to protect against the strongest of hurricanes. In particular, a “missile level D” represents a 9 pound 2×4 shot at 50 feet/second. Most storm protection systems for residential & commercial structures meet this standard 7 is applied to certain portions of the building (typically below 30 feet but with exceptions) in wind zones 1, 2 or 3 as described below. Missile Level E is enhanced impact protection and represents a 9 pound 2×4 shot at a prescribed pattern at 80 feet/second at glazed surfaces. The impact resistant between glass blind 10 of the present disclosure has passed impact testing for ASTM E1966-17 D and E. The tests were performed with the exterior first glass layer being tempered glass having a thickness of 5/32 inch and each of the heat strengthened layer 16A, 16B having a thickness of ¼ inch. The interlayer 20 is an 090 SGP to make the second laminated glass layer 16 having a thickness of 9/16 inch. In the test performed, the glass unit has a total thickness of 1 and ½ inches. The blind assembly 24 had a thickness of ¾ inch. The sealed interior chamber 18 can be filled with Argon gas and can be sealed all around with Hot Melt Butyl sealant or IGS3723 two-part insulating glass silicone sealant. Desiccant can also be provided inside the sealed interior chamber 18.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An impact resistant operable blind, comprising:
a sealed impact resistant unit including a first glass layer and a second laminated glass layer spaced from the first glass layer and defining a sealed chamber therebetween, the second laminated glass layer including a first heat strengthened glass layer laminated to a second heat strengthened glass layer by an interlayer; and
a blind unit within the sealed chamber and including a tiltrod supported at a top of the sealed chamber and supporting a plurality of ladder strings that support a plurality of slats.

2. The impact resistant operable blind according to claim 1, wherein the first heat strengthened glass layer and the second heat strengthened glass layer are at least ¼ inch thick.

3. The impact resistant operable blind according to claim 1, further comprising a magnetic device and tilt actuator for rotating the tiltrod to adjust a tilt of the plurality of slats.

4. The impact resistant operable blind according to claim 1, wherein the sealed chamber is filled with Argon gas.
